(19) United States
(12) Patent Application Publication
(10) Pub. No.: US 2022/0341793 A1
(43) Pub. Date: Oct. 27, 2022

(54) Flexible Temperature Probe

(71) Applicant: Photon Control Inc., Richmond (CA)

(72) Inventors: Celestino Andrew BORJA, Surrey (CA); Jose Jay Ruben Joven APELES, Coquitlam (CA); Lewis Vernon Milino JANZEN, Mill Bay (CA); Eric LIU, Coquitlam (CA)

(73) Assignee: Photon Control Inc., Richmond (CA)

(21) Appl. No.: 17/726,725

(22) Filed: Apr. 22, 2022

Related U.S. Application Data
(60) Provisional application No. 63/201,328, filed on Apr. 23, 2021.

(51) Int. Cl. G01K 11/32; G02B 6/36

(52) U.S. Cl. CPC G01K 11/32; G02B 6/3624

(57) ABSTRACT

A flexible fiber optic temperature probe is disclosed. The probe includes a plurality of fiber optic elements, a sensing member having a first and a second end, the first end connected to distal portions of the plurality of fiber optic elements, and a flexible jacket surrounding the plurality of fiber optic elements. The flexible jacket is engaged with the sensing member to prevent relative movement between the flexible jacket and the sensing member.

### CROSS-REFERENCE TO RELATED APPLICATION(S)

This application claims priority to U.S. Provisional Patent Application No. 63/201,328 filed on Apr. 23, 2021, the contents of which are incorporated herein by reference.

### TECHNICAL FIELD

The following generally relates to fiber optic based probes, and particularly to fiber optic based probes that can bend around a radius to thermally communicate with a desired location to be measured.

### BACKGROUND

Normally, fiber optic temperature probes are designed to include a solid, rigid, tube shaft having a connector end and a distal end. Existing fiber optic temperature probes include, inserted into the shaft, a solid and rigid fiber optic rod. A sensing element or ‘button’ is attached to the distal end of the shaft, and the fiber optic rod makes contact with the button to determine temperature based on light emitted by the sensing element. Existing probes can also include a spring on the connector end to bias the fiber optic rod into contact with the button.

### SUMMARY

Recognizing that traditional fiber optic temperature probes have difficulty bending to access a target area or surface in a difficult to reach area, the following provides a flexible temperature probe design that can accommodate a bend radius through which the probe is inserted.

Flexible temperature probes should allow for deformation, such that the probe bends around a tight radius port to make contact with, or thermally communicate with the object that is desired to be measured. A flexible shaft temperature probe has been developed that has a flexible polymer shaft (polytetrafluoroethylene (PTFE) in this example, although other polymers may be substituted depending on the bend radius and operating temperature of the environment) and has a flexible fiber optic bundle replacing the rigid glass rod.

In one aspect, a flexible fiber optic temperature probe is disclosed. The probe includes a plurality of fiber optic elements, and a sensing member. The sensing member has a first and a second end, the first end connected to distal portions of the plurality of fiber optic elements. The probe includes a flexible jacket surrounding the plurality of fiber optic elements and secured to with the sensing member to prevent relative movement between the flexible jacket and the sensing member.

In example embodiments, the first end of the sensing member is adhesively fixed to the distal portions of the of the plurality of fiber optic elements.

In example embodiments, the flexible fiber optic temperature probe further includes a member for engaging an opening of a channel, the member being a channel length distance from the sensing member. The aforementioned member is secured to prevent relative movement between the flexible jacket and the sensing member.

In example embodiments, a length of the sensing member enables the sensing member to pass through a minimum radius of a channel having one or more bends.

In example embodiments, a thickness of the sensing member enables the sensing member to pass through a minimum radius of a channel having one or more bends.

In example embodiments, the sensing member further includes a first portion having the first and the second end, and a tip portion having a sensing element, the tip portion secured to the second end. In example embodiments, the tip portion is removably secured to the second end.

In example embodiments, the flexible jacket is engaged with the sensing member by one or more of a friction fit, crimping, an overmold or a dip coat/potting compound, or an adhesive connection.

In example embodiments, the flexible jacket is at least in part disposed between an exterior portion and an interior portion of the sensing member, and the flexible jacket is crimped to one or more of the exterior portion or the interior portion. In example embodiments, the interior portion of the sensing member includes a clearance at least in part able to receive the flexible jacket on an exterior surface. In example embodiments, the exterior portion of the sensing member extends further from a distal end of the sensing member than the interior portion, and the exterior portion is crimped with the flexible jacket to at least in part interfere with axial movement of the interior portion relative to the exterior portion.

In another aspect, a method of assembling a flexible fiber optic temperature probe is disclosed. The method includes inserting a plurality of fiber optic elements within a channel defined by a flexible jacket and securing distal portions of the plurality of fiber optic elements to a sensing member. The method includes securing the flexible jacket to the sensing member.

In example embodiments, securing distal portions of the plurality of fiber optic elements to a sensing member further comprises inserting the distal portions of the plurality of fiber optic elements through an interior channel of the sensing member.

In example embodiments, the method further includes securing a member for engaging an opening of the channel a channel length distance from the sensing member.

In example embodiments, the plurality of fiber optic elements are inserted within a channel defined by a flexible jacket subsequent to securing the distal portions of the plurality of fiber optic elements to the sensing member.

In example embodiments, securing the flexible jacket to the sensing member comprises crimping the flexible jacket to one or more of an exterior portion or an interior portion of the sensing member.

In example embodiments, the sensing member includes a first portion and a second portion comprising a sensing element secured to one another, the method further comprising attaching the first portion to the second portion. In example embodiments, the first portion and the second portion are removably attached to one another.

In example embodiments, securing the flexible jacket to the sensing member comprises securing a portion of the flexible jacket to a recessed portion of the sensing member.

In another aspect, an assembly including a temperature sensor is disclosed. The assembly includes a body including a channel having at least one bend, the channel ending at an edge. The assembly includes a temperature probe comprising a plurality of fiber optic elements, a sensing member having a first and a second end, the first end connected to distal portions of the plurality of fiber optic elements, and a flexible jacket surrounding the plurality of fiber optic elements and engaged with the sensing member to prevent relative movement between the flexible jacket and the sensing member. The temperature probe is at least in within the channel and passes through the at least one bend to have the sensing member thermally communicate with the edge.

In example embodiments, the assembly further includes a mechanism to bias the sensing member to contact the edge.

In another aspect, a flexible fiber optic temperature probe is disclosed. The probe includes a bundle of fiber optic elements, and a collar having an internal channel, the collar being secured to end portions of the bundle within the internal channel. The probe includes a sensing member including a first part and a second part, where the first part includes: a channel for receiving the collar, the first part being secured to the collar within the channel; and a projection capable of being secured to adjacent walls. The second part includes a sensing element.

In example embodiments, the first part and the second part are removably attached.

In example embodiments, the first part is adhesively fixed to the collar.

In example embodiments, the projection includes one or more surfaces for laser welding with the adjacent walls.

In example embodiments, at least part of the first part is insertable within a passage defined by the adjacent walls, and the projection prevents another part of the first part from being insertable within the passage.

In yet another aspect, a ferrule and gluing method on the distal end of the tube is disclosed that can allow threading in of the phosphor button. Moreover, there is disclosed a ferrule on the near connector end to provide attachment of the flexible tubing to the connector nut and not cause damage or separation of the flexible tube to the connector.

Additionally, the phosphor can be attached to the fiber with an overmold or dip coat/potting compound.

### BRIEF DESCRIPTION OF THE DRAWINGS

Embodiments will now be described with reference to the appended drawings wherein:

FIG. 1 is a partial cross-sectional view of a body having a channel.

FIG. 2 is an enlarged cross-sectional view of the bend in the channel shown in FIG.

FIGS. 3A and 3B are schematic views illustrating example sensing elements interacting with a channel.

FIG. 4 is a perspective view of an example flexible temperature probe.

FIGS. 5A and 5B are cross sectional diagrams of the example flexible temperature probe in FIG. 4.

FIG. 6 is an enlarged cross-sectional diagram of an example member of a temperature probe.

FIGS. 7A and 7B are each cross-sectional diagrams of example sensing members.

FIGS. 7C and 7D are each a perspective diagram of another example sensing member.

FIGS. 8A and 8B are block diagrams showing example methods of assembling an example flexible temperature probe.

FIGS. 9A to 9E provides a series of images illustrating methods for assembling an example flexible temperature probe.

FIG. 10 illustrates another example embodiment of a flexible temperature probe.

FIG. 11 is a block diagram showing an example method of assembling an example flexible temperature probe.

FIG. 12 is a block diagram showing an example method of measuring a desired area with an example flexible temperature probe.

### DETAILED DESCRIPTION

Hereinafter, it is understood that the terms sensor and probe shall be used interchangeably to at least refer to a device that measures temperature, unless indicated otherwise. Moreover, for ease of reference, the terms sensor and probe shall be understood to mean a flexible temperature probe or sensor, as described herein.

Existing optical temperature sensors are rigid, having a rigid optical rod to contact a sensing element, and possibly including a rigid shell to accommodate the rigid optical rod.

The present disclosure relates to flexible optical probes. The disclosed probe potentially satisfies or alleviates the following concerns which arise where a rigid rod is not used as a medium to transmit the light from the sensor: (1) protection of the medium from external light pollution, or physical damage owing to the external environment, (2) providing a means of ensuring signal continuity notwithstanding installation or access geometry having bends, (3) attaching the medium to the probe tip reliably and without impacting the performance of the probe, and (4) avoiding unnecessarily complex manufacturing or relatively expensive, or relatively unavailable constituent elements.

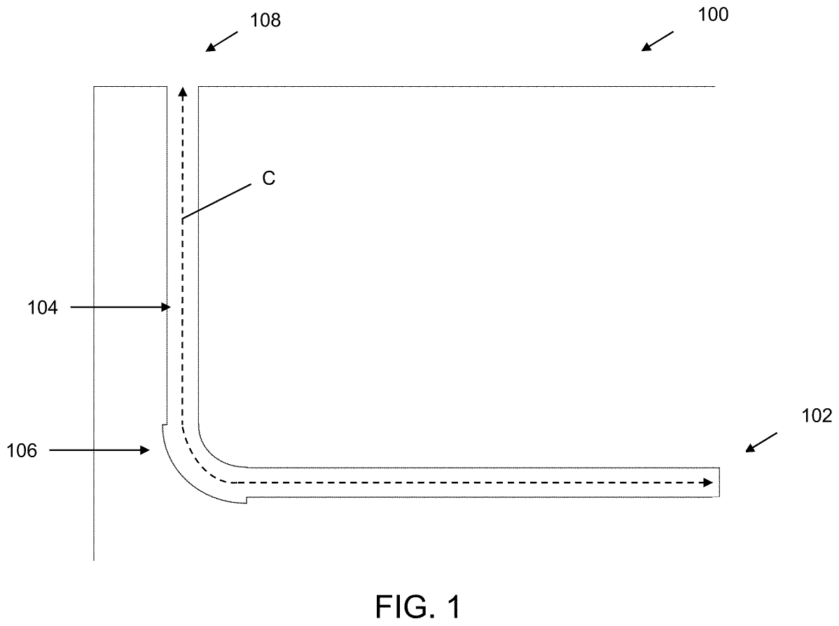

Turning now to the figures, FIG. 1 illustrates a partial view of a body 100 having a channel 104. In an example embodiment, the body 100 is a showerhead in a semiconductor processing chamber. The channel 104 includes a surface 102, and in various applications measuring the temperature of the surface 102 is desirable (e.g., the aforementioned showerhead in a semiconductor processing chamber). To measure the temperature of the surface 102 (or any part of body 100 that defines or is within a radio frequency (RF) hot part or zone) a sensor or probe is positioned to engage or to substantially thermally communicate with the surface 102 (e.g., be located within a proximity such that the sensing element provides a response to temperature variations at the surface 102). In some example embodiments, for example, the temperature at the surface 102 of the body 100 can be used a proxy of a temperature of a desired area (e.g., a temperature in the middle of a body 100), and therefore a sensor may desirably be placed to measure the temperature of the surface 102.

The channel 104 includes at least one bend 106 and has a channel length C defined by the distance a probe needs to travel from the opening 108 of the channel 104 to the desired location (e.g., here, the surface 102). It is understood that the shown channel length C is illustrative, and the channel length C includes permutations of a probe travelling the length of the channel 104 other than directly. For example, the channel length C includes channel lengths where the probe has kinks or other types of variations that increase or decrease the length of probe required to contact the desired area.

The bend 106 can be of a variety of different sizes, and include a variety of different features, as will be discussed below. In at least one example embodiment, the body 100 includes multiple bends (not shown), however, for the sake of simplicity, the discussion shall refer to scenarios where a single bend is encountered.

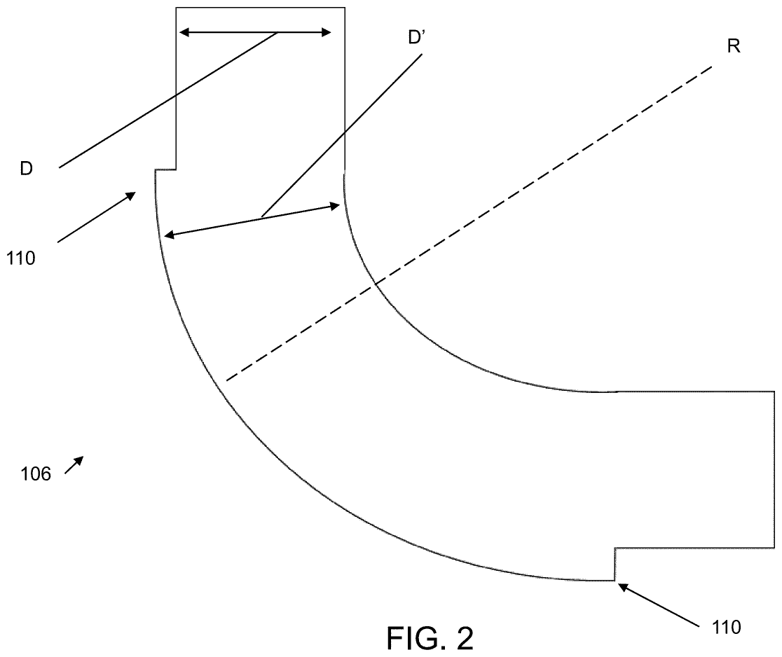

FIG. 2 illustrates an enlarged cross-sectional view of the bend 106 to highlight difficulties associated with inserting a flexible temperature probe into the bend 106. Accessing the surface 102 of the body 100 with a probe can pose a difficulty, particularly where the bend 106 includes a tight bend radius R (shown in an exaggerated manner for ease of reference), which in the shown example is 1″.

Similarly, as alluded to above, the bend 106 can include one or more features which impede a probe passing through the channel 104. For example, the shown bend 106 includes variations that can obstruct a probe passing through the bend 106. A variety of variations are contemplated by this disclosure. For example, in the shown embodiment, the variation is defined by a single continuous step 110 which expands the channel 104, such that the variation is defined by a diameter D′ that is greater than the diameter D of the channel 104 in regions other than in the variation. A probe passing through the channel 104 could potentially be stopped from passing further into the channel 104 by the steps 110.

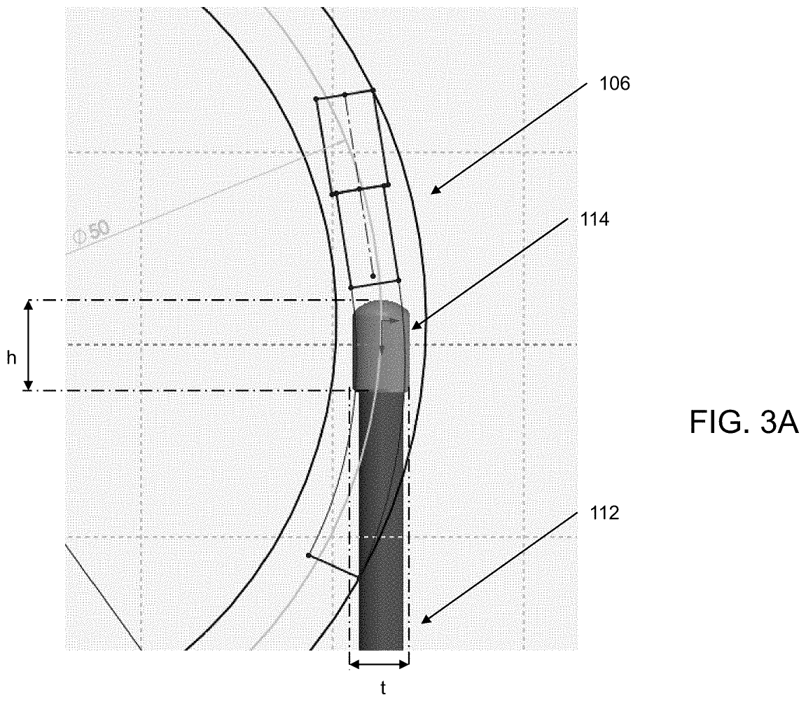

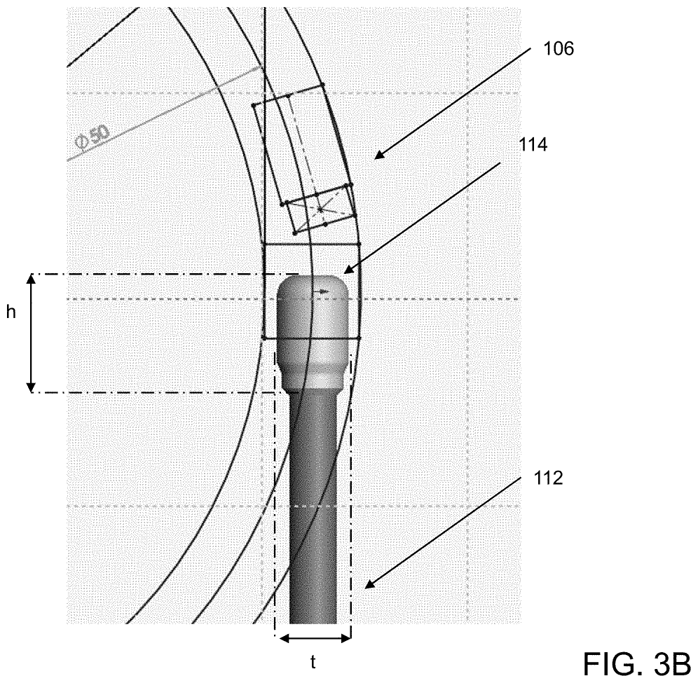

FIGS. 3A and 3B further illustrate complications associated with the inserting a temperature probe into the channel 104. In the shown embodiments, the probe 112 includes a rigid or substantially rigid sensing member 114, having both a thickness t (e.g., a diameter), and a height h that can impede the passage of the probe 112 through the channel 104.

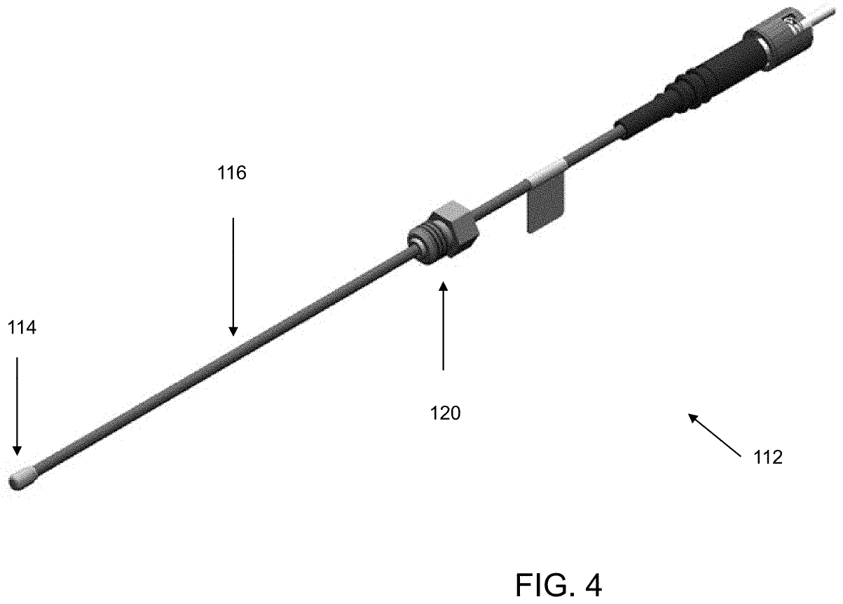

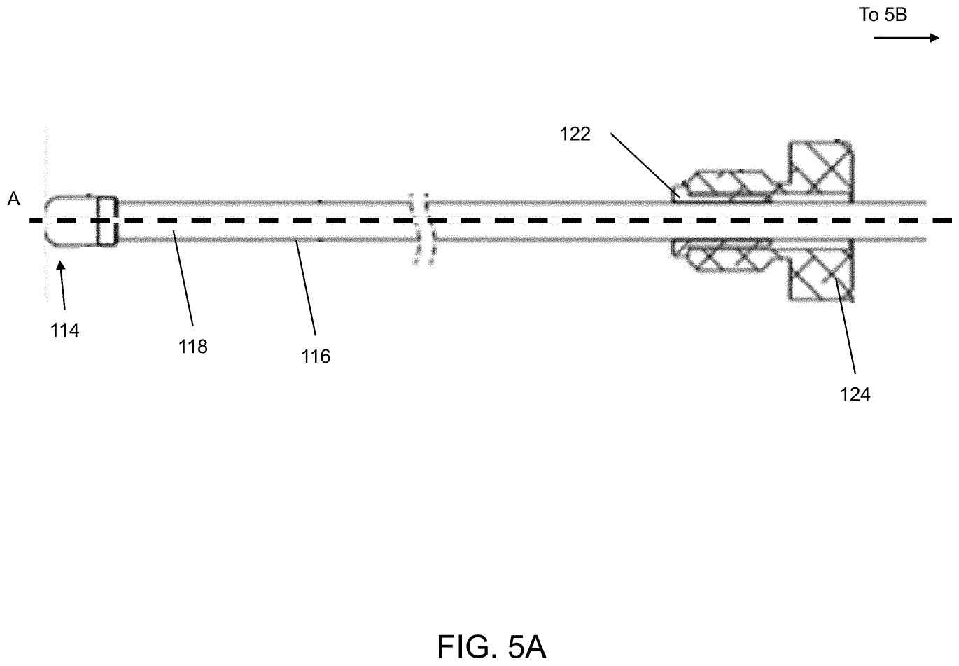

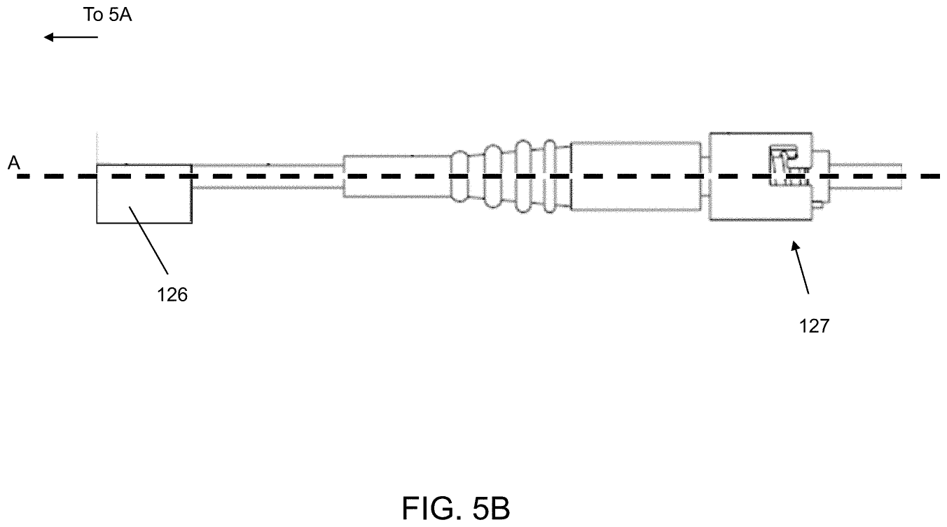

Referring now to FIGS. 4, 5A and 5B, various views of an example flexible temperature probe 112 are shown. The probe 112 includes a sensing member 114 and a flexible jacket 116 that surrounds a plurality of fiber optic elements 118. The probe 112 may further include a member 120 for engaging the opening 108 of the channel 104. The member 120, in the embodiment shown, includes both a first part 122 (e.g., a retainer) and a second part 124 (e.g., a nut that engages the retainer first part 122). As will be described herein, the member 120 can be used to configure the probe 112 to be of a channel length C or length substantially similar thereto.

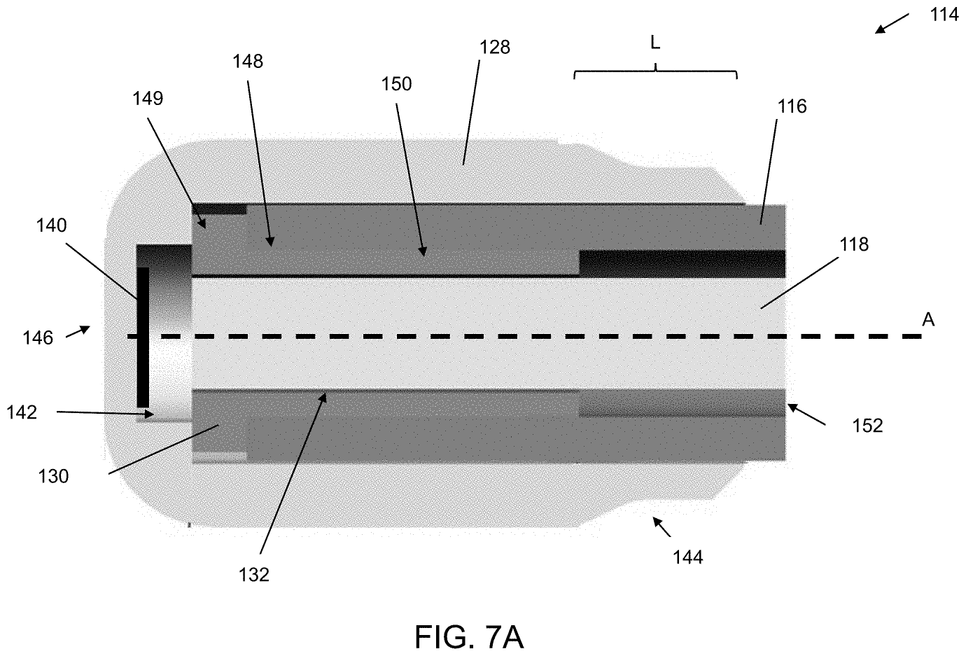

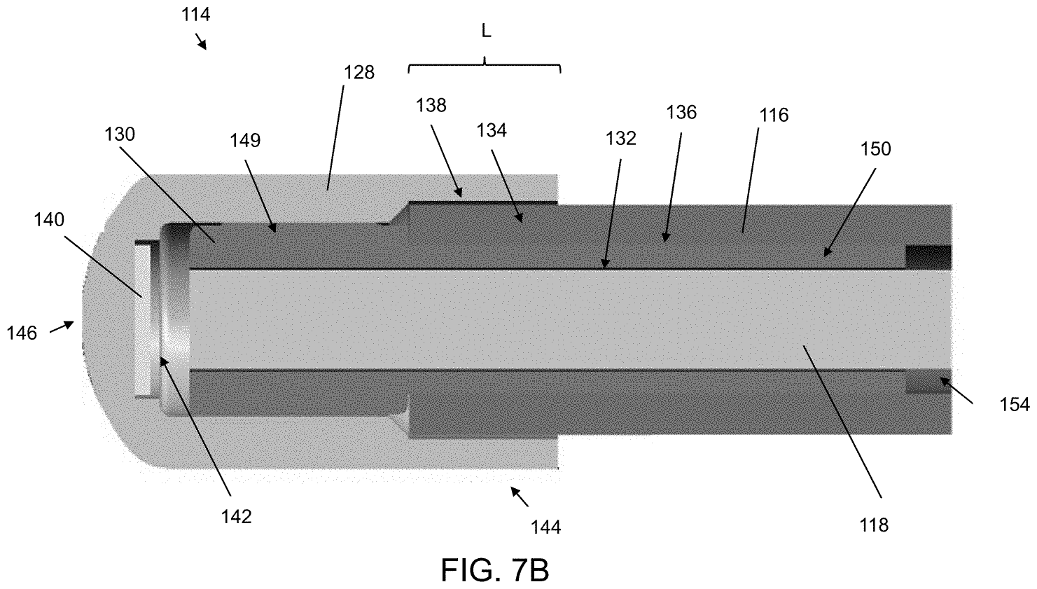

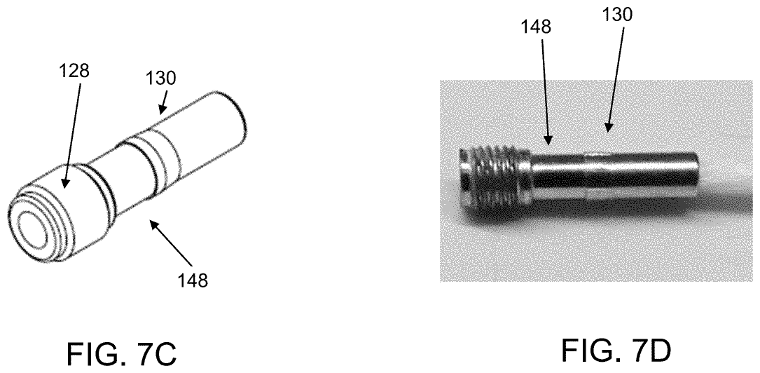

The jacket 116 includes a channel into which the plurality of fiber optic elements 118 can be inserted. For example, the jacket 116 includes a channel 154 (FIG. 7B) that is formed as a result of the material properties when the jacket 116 was formed. In at least some example embodiments, the jacket 116 is biased to reduce the channel cross sectional area to contact the plurality of fiber optic elements 118. Examples of jacket materials include jackets made of polytetrafluoroethylene (PTFE), or other types of polymers, etc.

The probe 112 can include a label 126, and a mechanism 127 (e.g., a spring-loaded mechanism) to bias the sensing member 114 towards a surface (e.g., surface 102). The mechanism may be part of a standard straight tip (ST) connector at a connection end of the probe 114.

Also shown in FIGS. 5A and 5B is an axis A, located at approximately the center of the plurality of fiber optic elements 118. Hereinafter, the terms “outward” or “inward”, or similar terms, shall be used to denote radial directions relative to the axis A. For example, outward surfaces are further away from the axis A as compared to inward surfaces.

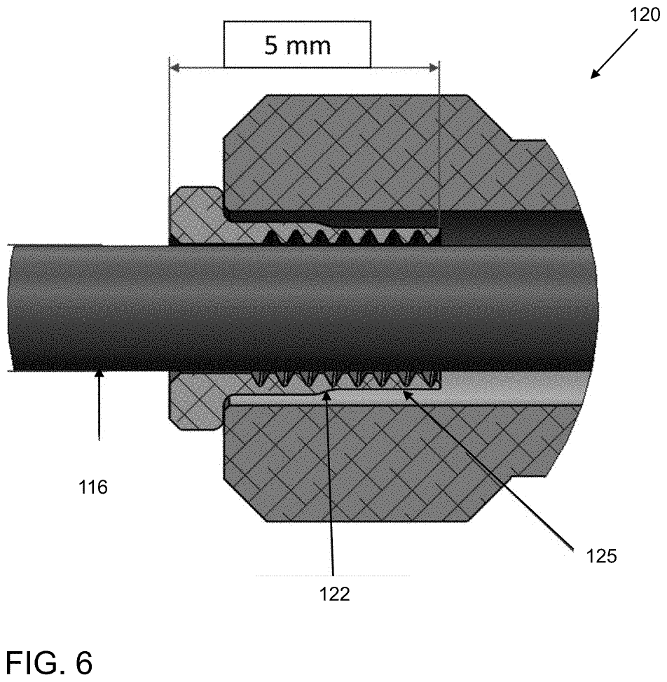

Referring now to FIG. 6, an enlarged cross-sectional diagram of an example member 120 for engaging the opening 108 of the channel 104 is shown. Similar to the sensing member 114, as will be discussed herein, the second part 122 may include a zone 125 having a smaller radial thickness where crimping is expected.

Referring now to the sensing member 114, properties of the sensing member 114 can be adjusted to facilitate the probe 112 passing through the channel 104. For example, the sensing member 114 can be selected to have a thickness t or height h capable of passing through a diameter D of a smallest bend 106 in a channel 104.

FIGS. 7A to 7D illustrate different example configurations of the sensing member 114. In the shown embodiments, the sensing member 114 includes a tip 128 and another part (e.g., a ferrule 130) disposed inward relative to the tip 128. The ferrule 130 includes a channel 132 for receiving the plurality of fiber optic elements 118 between a first end and a second end of the ferrule 130, where the first and second end of the ferrule 130 are axially opposite one another relative to the illustrative axis A. The ferrule 130 is secured to a portion of the plurality of fiber optic elements 118 within the channel 132, as shown in FIGS. 7A and 7B. The ferrule 130 and the plurality of fiber optic elements 118 can be secured to one another in a variety of manners. For example, the plurality of fiber optic elements 118 and the ferrule 130 may be adhered to one another with a glue which does not impede the performance of the fiber optic elements 118. In at least some example embodiments, the ferrule 130 may be at least in part deformable, and the ferrule 130 may be deformed to secure the plurality of fiber optic elements 118. The portion of the plurality of fiber optic elements 118 that is secured to the ferrule 130 shall be understood to be the distal portion of the plurality of fiber optic elements 118. It is noted that the tip 128 may be referred to alternatively as an exterior portion, and the ferrule 130 can be referred to as the interior portion.

The tip 128 and the ferrule 130 are securable to one another such that the sensing element 140 is in optical communication with the distal ends of the elements 118, as shown. In example embodiments, as shown in FIGS. 7C and 7D, the tip 128 is threaded onto the ferrule 130. In some example embodiments, the tip 128 is secured to the ferrule 130 at least in part with an overmold (e.g., a melt-processable or sintered fluoropolymer) or dip coat/potting compound. In example embodiments, the tip 128 and the ferrule 130 are secured to one another via adhesives. In still further illustrative example embodiments, the tip 128 and the ferrule 130 are secured to one another via crimping. For example, in FIGS. 7A and 7B, the tip 128 can be crimped along the section L, such that after deformation of the tip part 138 inwards, the deformed tip part 138 at least in part interferes with axial movement of the ferrule 130 relative to the tip 128. In at least some example embodiments, the tip 128 and the ferrule 130 are crimped to one another. For example, in FIGS. 7C and 7D, the ferrule 130 includes a recess 148. The tip 128 can be crimped at a location that overlaps the recess 148, securing the tip 128 to the ferrule 130.

Optionally, as shown in FIGS. 7A to 7B, the ferrule 130 can include a clearance 134 defined by an exterior surface 136 at least in part able to receive the flexible jacket 116. For example, as shown in FIG. 7A, the clearance 134 results from a thickness of the ferrule 130 and the interior surface 138 of the tip 128, which collectively define the clearance 134. In example embodiments, the clearance 134 is defined by the thickness of the ferrule 130 relative to other parts of the ferrule 130. The clearance 134 can receive the jacket 116 therein, as shown. Where the tip 128 to the ferrule 130 are crimped together and there is a clearance 134, advantageously the crimping can secure the jacket 116 to the tip 128 or the ferrule 130 or both.

The tip 128 includes the sensing element 140. The sensing element 140 can be made from a phosphor compound disc, or other material(s) suitable for temperature measurement. In the shown embodiments, the sensing element 140 is disposed within a cavity 142 within the tip 128. The sensing element 140 can be secured to the interior of the tip 128128, for example, by adhesive bonding, or by overmolding, etc.

The exterior profile of the tip 128, for example defined in part by the contour 144 and the distal end contour 146, can be configured or selected based on expected properties of the channel 104 and the bends 106 therein. For example, the sensing member of FIG. 7B can be selected for use in applications being installed in a situation having a smaller expected bend 106, as the distal end contour 146 of FIG. 7B is slimmer compared to the similar contour of the sensing member 114 in FIG. 7A,

Similarly, and in example embodiments, complimentary to the configuration of the tip 128, the ferrule 130 can be configured based on expected properties of the channel 104 and the bends 106 therein. For example, again referring to FIGS. 7A and 7B, a head 149 of the ferrule 130 (in contrast to the tail 150) can have a radial thickness that permits passage through the expected diameter D of the channel 104 when secured to the tip 128, or a length that permits passage through the expected bend 106 radius R.

Also illustrated in FIG. 7A is that the tail 150 can have a radial thickness such that, for example, when the jacket 116 is slid over the tail 150 to secure the jacket to the tail 150, a clearance 152 between the jacket 116 and the ferrule 130 is formed. Moreover, similar to the member 120, the ferrule 130 as a whole, or the tail 150, or the head 149, can have a radial thickness that varies across different axial portions of the ferrule 130.

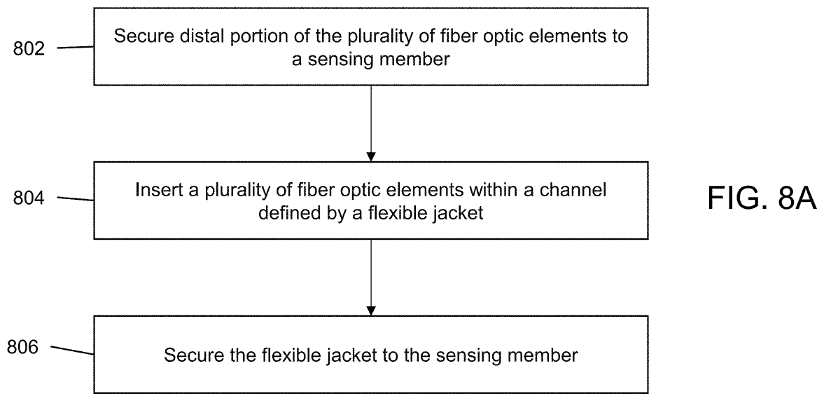

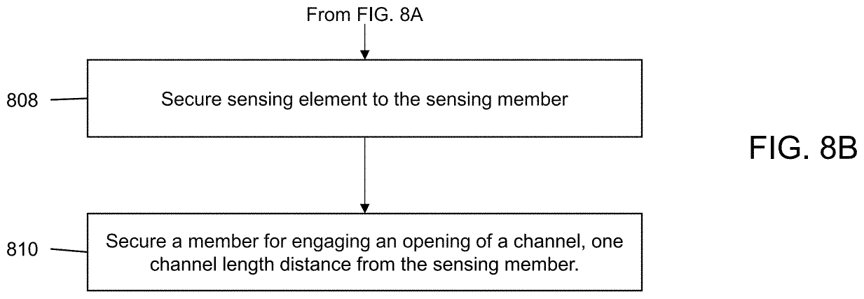

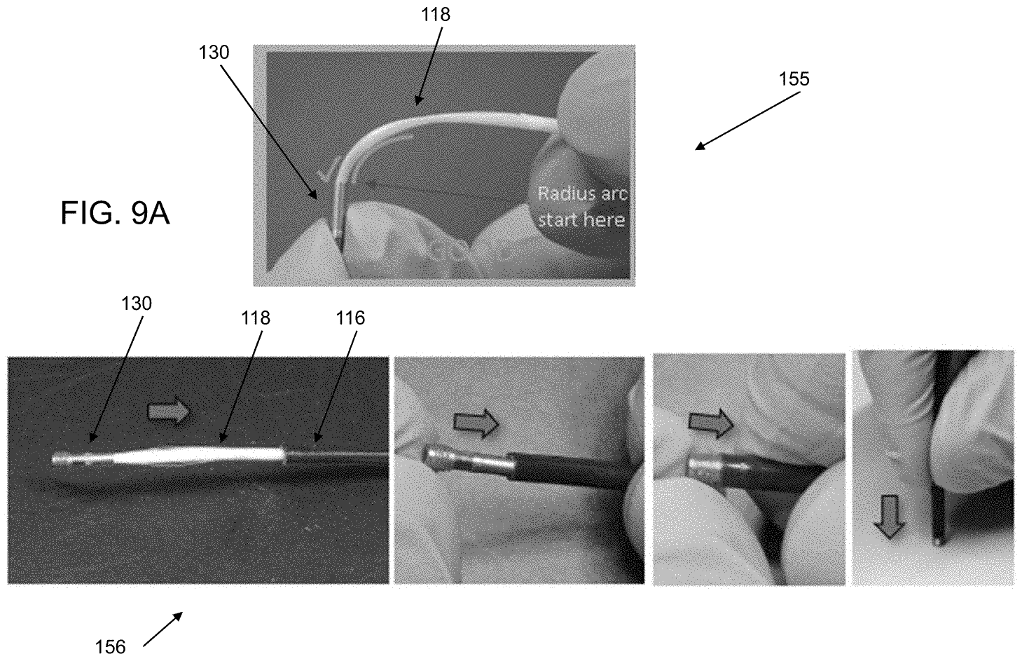

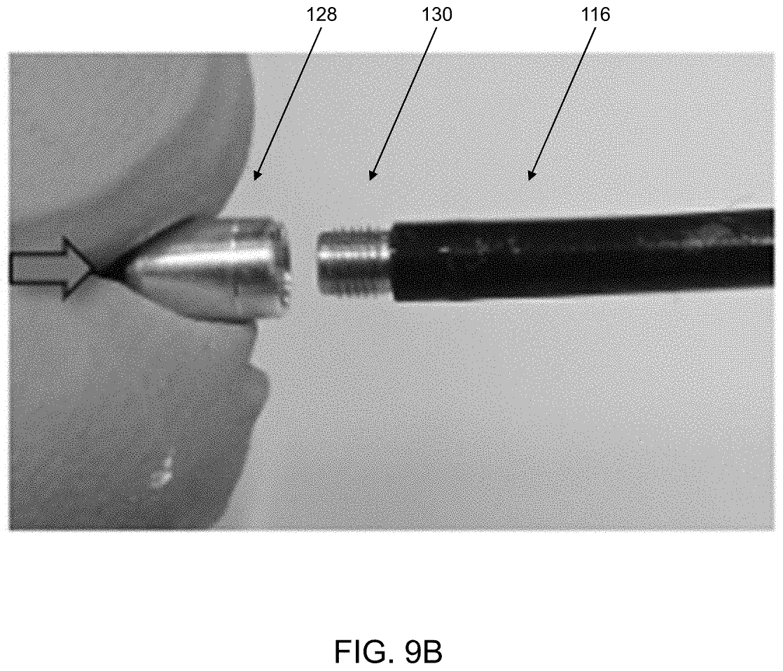

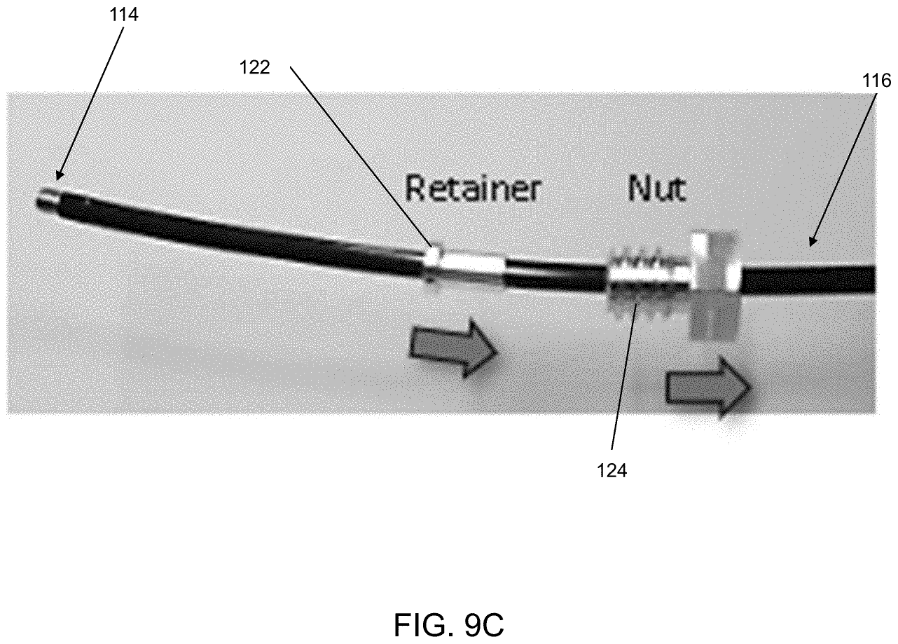

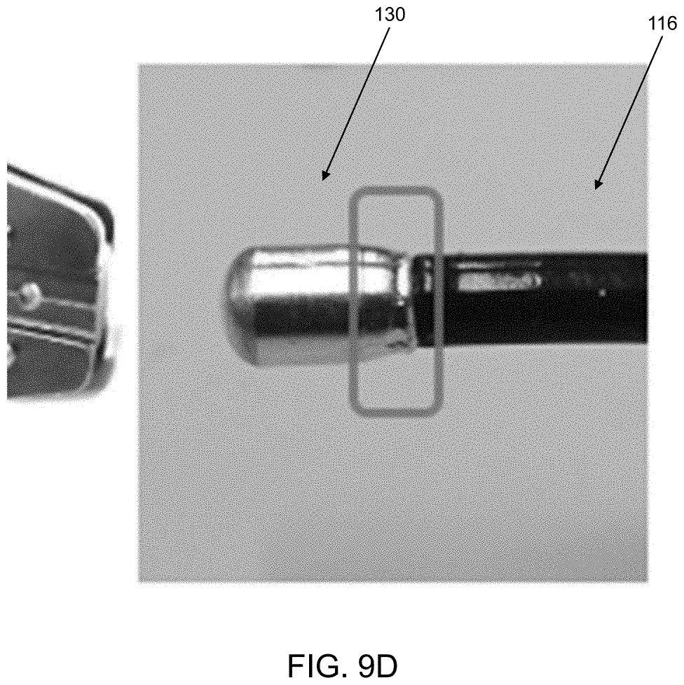

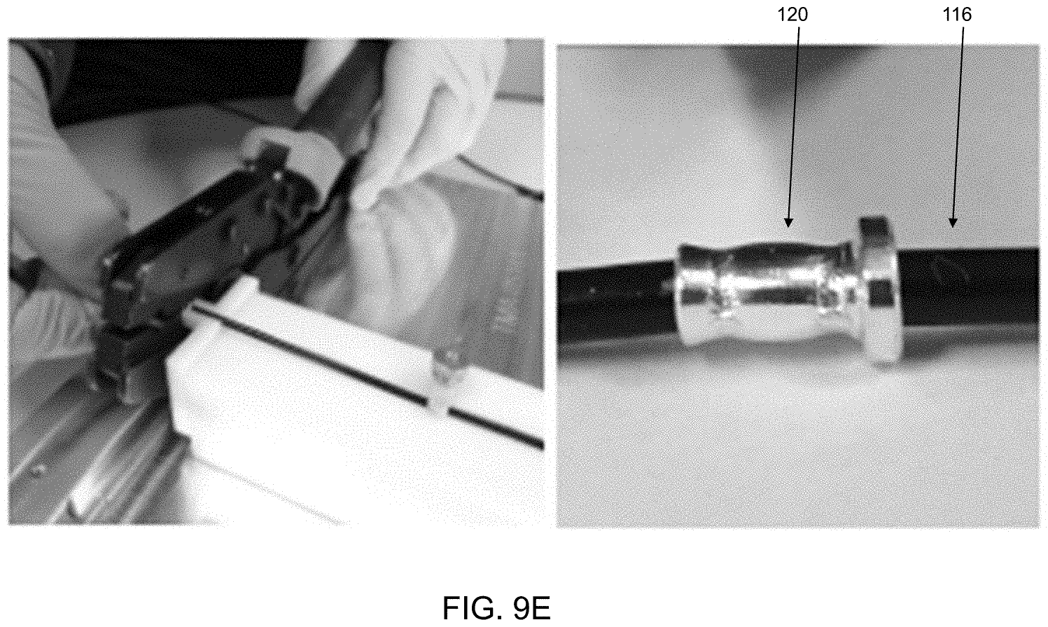

Referring now to FIG. 8A, a block diagram of an example method of assembling an example flexible temperature probe is shown. FIG. 8A shall be discussed with reference to FIGS. 9A, 9B and 9D to illustrate the example method.

At block 802, distal portions of the plurality of fiber optic elements 118 are secured to a sensing member 114 (e.g., the ferrule 130 of the sensing member 114). Image 155 of FIG. 9A shows the secured plurality of fiber optic elements 118 in a bent configuration. In at least one example embodiment, securing distal portions of the plurality of fiber optic elements 118 includes inserting the distal portions of the plurality of fiber optic elements 118 through an interior channel (e.g., channel 132) of the sensing member 114 and securing the elements 118 to the channel walls.

At block 804, the plurality of fiber optic elements 118 are inserted within a channel (e.g., channel 154) defined by the flexible jacket 116.

At block 806 the flexible jacket 116 is secured to the sensing member 114. For example, as shown in FIG. 9D, the jacket 116 can be secured to the sensing member 114 of FIGS. 7C and 7D via a crimping process. The shown crimping is performed at or approximate to the recess 148, where prior to crimping the flexible jacket 116 is overlayed over the recess 148, and the crimping secures the flexible jacket 116 to the ferrule 130. In example embodiments, the jacket 116 is overlayed over the recess 148 and further overlays a portion of the tip 128, such that the crimping secures the jacket 116, the tip 128, and the ferrule 130 to one another.

In example embodiments, similar to the connection between the tip 128 and the ferrule 130, the jacket 116 can be secured to the sensing member 114 via an overmold (e.g., a melt-processable or sintered fluoropolymer) or dip coat/potting compound. Some fluoropolymers like perfluoroalkoxy alkanes (PFA) are melt-processable and PFA could be an alternate material for the jacket 116.

Images 156 show an example process of inserting the plurality of fiber optic elements 118 into the jacket 116, which includes sliding the jacket over the elements 118. In the shown example, the jacket 116 can be secured with a friction fit with the ferrule 130 through the application of force. As discussed above, in at least some example embodiments, the jacket 116 is secured to the ferrule 130 via a combination of one or more of adhesion, crimping, or other means.

It is understood that the disclosure contemplates blocks 802, 804, and 806 occurring in different sequence to the sequence shown in FIG. 9A. For example, block 804 can occur prior to block 802.

Referring now to FIG. 8B, a block diagram of another example method of assembling an example flexible temperature probe is shown. FIG. 8B shall be discussed with reference to FIGS. 9B to 9E to illustrate the example method. Blocks 802 to 806 in FIG. 8A are incorporated into the method shown by FIG. 8B, as shown.

At block 808, and wherein block 802 included attaching the elements 118 and the jacket 116 to a sensing member 114 without a sensing element (i.e., unassembled), the tip 128 having the sensing element 140 of the sensing member 114 is secured to the ferrule 130, completing assembly of the sensing member 114. In example embodiments, the tip 128 is removably attached to the ferrule 130, for example via a threaded connection, as shown in FIG. 9B.

At block 810, a member 120 for engaging an opening 118 of a channel 104 a channel length distance from the sensing member 114 is secured to the jacket 116. For example, FIG. 9C shows example parts 122 and 124 (a retainer and nut, respectively) being slid onto the jacket 116, passing over the sensing element 114. FIG. 9E shows an example process of securing the member 120 to the jacket 116 which includes crimping, and the subsequent deformation of the member 120.

It is understood that, while throughout this disclosure the sensing member 114 has been described as being composed of separate parts, one or more of the constituent parts, or the entire sensing member 114, may be a single part. That is, the sensing member 114 can include various unitary combinations of the described constituent parts. For further certainty, the sensing member 114, for example, can be comprised of a unitary tip 128 and ferrule 130.

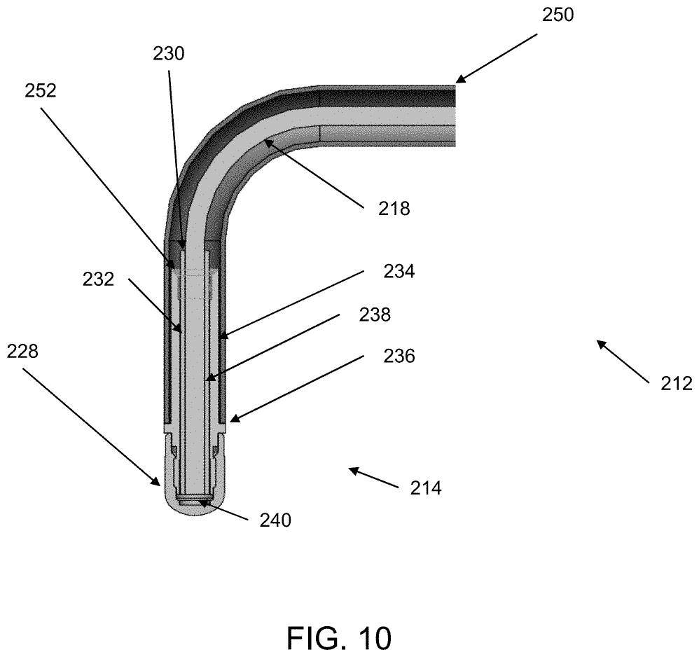

FIG. 10 illustrates another example embodiment of a flexible temperature probe 212. The probe 212 includes a bundle of fiber optic elements 218, and a sensing member 214. The bundle of fiber optic elements 218 are configured or selected to be able to pass through a passage (analogous to the channel 104) defined by a rigid wall 250 (e.g., walls machined into a stainless-steel body to define a passage). For example, the bundle 218 thickness or length may be selected for the desired application.

The sensing element 214 includes a collar (e.g., an inner ferrule 230), a tip 228, and an intermediary part (e.g., an outer ferrule 234). The inner ferrule 230 includes an internal channel 232 for receiving the bundle of fiber optic elements 218. Similar to the ferrule 130, the inner ferrule 230 is secured to end portions of the bundle 218 within the internal channel 232. In at least some example embodiments, the inner ferrule 230 is a part separate from the sensing member 214. For example, the end portions of the bundle 218 can be secured to the inner ferrule 230 (e.g., via gluing) prior to the inner ferrule 230 being secured to the sensing element 214. The inner ferrule 230 can be glass to at least in part address concerns related to bundle 218 optical performance, or to address concerns about heat dissipation, as discussed herein.

In at least one example embodiment, the end portions of the bundle 218 can be secured to the inner ferrule 230, and the inner ferrule 230 is passed through the passage defined by wall 250 to an opening. The inner ferrule 230 is thereafter secured to outer ferrule 234, which itself includes a channel 238 for receiving the inner ferrule 230. The outer ferrule 234 can be a rigid metal part, and the inner ferrule 230 can be secured to the outer ferrule 234 via, for example, glue or other attachment mechanisms. In example embodiments, for example, the inner ferrule 230 and the outer ferrule 234 are secured at a portion 252 of the outer ferrule 234 which is distant from projections (as described herein) of the outer ferrule 234, as said projections may be subject to thermal loading which can potentially adversely impact the securing means. In example embodiments, the outer ferrule 234 at portion 252 includes a funnel configuration to facilitate receiving the inner ferrule 230 into the channel 238.

In at least some example embodiments, the outer ferrule 234 includes one or more projections 236 that are capable of being secured to adjacent walls (e.g., wall 250). The projections 236 can be secured to the adjacent portion of wall 250 by, for example, laser welding of an outer surface of the projection 241 to the adjacent wall portion, generating the heat alluded to earlier, or via gluing, etc. Securing the outer ferrule 234 to the adjacent portion of wall 250 via the projections 236 closes the opening in the wall 250. In this way, the environment within the passage of the wall 250 is isolated from the environment outside of the sensing element 214.

The projections 236 can fit within the passage defined by the wall 250 through which the bundle 218 is passed, or as shown in FIG. 10, the projections 236 can prevent at least one part of the outer ferrule 234 from being insertable within the passage defined by the wall 250. Where the projections 236 cannot be inserted, advantageously the outer ferrule 234 can secured to the inner ferrule 230 away from the possibly cramped location of the opening in the wall 250 for assembly, and the secured inner ferrule 230 and the outer ferrule 234 can thereafter be placed to close the opening in the wall 250 with the projections 236.

The tip 228 can include a sensing element 240, and is secured to the intermediary part 234, so that the sensing element 240 is in optical communication with the distal ends of the bundle 218, as shown. The parts can be secured in a variety of manners. For example, the sensing element 240 and the outer ferrule 234 can be removably attached, via a threaded engagement, or secured via an adhesive, etc. In at least some example embodiments, the sensing element 240 and the outer ferrule 234 form a single unitary part.

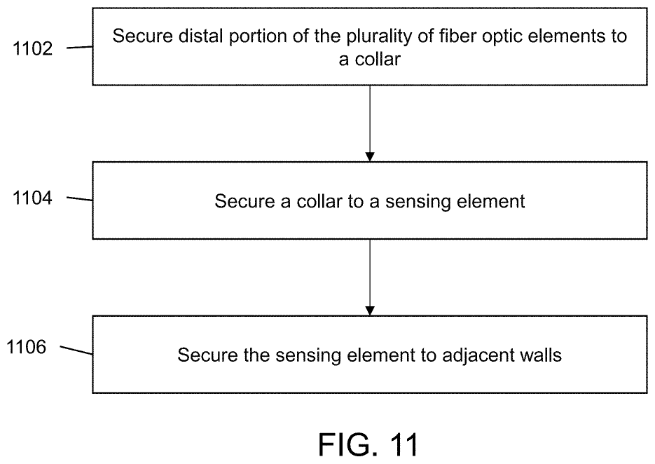

Referring now to FIG. 11, a block diagram of an example method of assembling an example flexible temperature probe 212 is shown.

At block 1102, the distal portion of the bundle 218 is secured to the inner ferrule 230.

At block 1104, the inner ferrule 230 secured to the sensing element 214.

At block 1106, the sensing element is secured to adjacent walls 250.

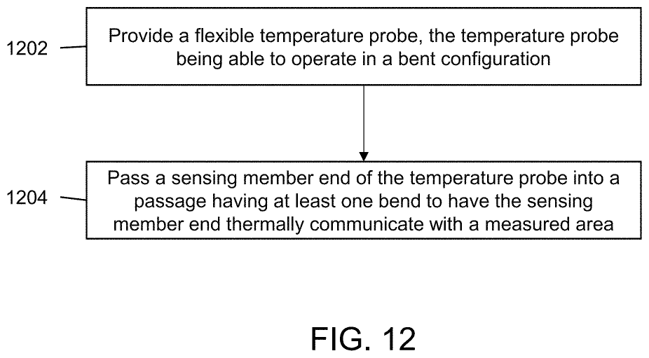

Referring now to FIG. 12, a block diagram of an example method of measuring a desired area with an example flexible temperature probe is shown. The method of FIG. 12 shall be discussed with reference to probe 112 for ease of illustration.

At block 1202, the flexible temperature probe 112 that can operate within a bent configuration is provided. The bent configuration can be defined by the smallest bend 106 in a channel 104 into which the probe 112 is being installed.

At block 1204, the sensing member 114 of the temperature probe is passed through a channel (e.g., channel 104) having at least one bend (e.g., bend(s) 106) to have the sensing element 114 thermally communicate with the desired area. In example embodiments, the desired area is a surface (e.g., surface 102).

Passing the probe 112 can include passing the sensing element 114 past any obstructions or variations before insertion into the channel 104. In example embodiments, for example, there is a top plate (not shown) above the opening 118 into the channel 104 shown at the top of the image in FIG. 1. As noted, the sensing element 114 can be configured or selected based on the channel 104 and bend 106 properties (e.g., the sensing element of FIG. 3B, the sensing element when compared to FIG. 3A, may be selected, as it may be able to bend around a smaller bend radius, which makes it easier to avoid obstructions and variations).

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

What is claimed is:

1. A flexible fiber optic temperature probe, the probe comprising:
a plurality of fiber optic elements;
a sensing member having a first and a second end, the first end connected to distal portions of the plurality of fiber optic elements; and
a flexible jacket surrounding the plurality of fiber optic elements and secured to the sensing member to prevent relative movement between the flexible jacket and the sensing member.

2. The flexible fiber optic temperature probe of claim 1, wherein the first end of the sensing member is adhesively fixed to the distal portions of the of the plurality of fiber optic elements.

3. The flexible fiber optic temperature probe of claim 1, further comprising:
a member for engaging an opening of a channel, the member being a channel length distance from the sensing member, the member secured to prevent relative movement between the flexible jacket and the sensing member.

4. The flexible fiber optic temperature probe of claim 1, wherein a length of the sensing member enables the sensing member to pass through a minimum radius of a channel having one or more bends.

5. The flexible fiber optic temperature probe of claim 1, wherein a thickness of the sensing member enables the sensing member to pass through a minimum radius of a channel having one or more bends.

6. The flexible fiber optic temperature probe of claim 1, wherein the sensing member further comprises:
a ferrule having a first end and a second end;
a tip having a sensing element, the tip secured to the second end.

7. The flexible fiber optic temperature probe of claim 6, wherein the tip is removably secured to the second end.

8. The flexible fiber optic temperature probe of claim 1, wherein the flexible jacket is secured to the sensing member by one or more of a friction fit, crimping, an overmold or a dip coat/potting compound, or an adhesive connection.

9. The flexible fiber optic temperature probe of claim 8, wherein the flexible jacket is disposed at least in part between an exterior portion and an interior portion of the sensing member, and the flexible jacket is crimped to one or both of the exterior portion or the interior portion.

10. The flexible fiber optic temperature probe of claim 9, wherein the interior portion of the sensing member includes a clearance at least in part able to receive the flexible jacket on an exterior surface.

11. The flexible fiber optic temperature probe of claim 9, wherein the exterior portion of the sensing member extends further from a distal end of the sensing member than the interior portion, and the exterior portion is crimped with the flexible jacket to at least in part interfere with axial movement of the interior portion relative to the exterior portion.

12. A method of assembling a flexible fiber optic temperature probe, the method comprising;
inserting a plurality of fiber optic elements within a channel defined by a flexible jacket;
securing distal portions of the plurality of fiber optic elements to a sensing member; and
securing the flexible jacket to the sensing member.

13. The method of claim 12, wherein securing the distal portions of the plurality of fiber optic elements to the sensing member further comprises inserting the distal portions of the plurality of fiber optic elements through an interior channel of the sensing member.

14. The method of claim 12, further comprising:
securing a member for engaging an opening of the channel a channel length distance from the sensing member.

14. The method of claim 12, wherein the plurality of fiber optic elements are inserted within a channel defined by the flexible jacket subsequent to securing the distal portions of the plurality of fiber optic elements to the sensing member.

15. The method of claim 12, wherein securing the flexible jacket to the sensing member comprises crimping the flexible jacket to one or more of an exterior portion or an interior portion of the sensing member.

16. The method of claim 12, wherein the sensing member includes a first portion and a second portion comprising a sensing element secured to one another, the method further comprising attaching the first portion to the second portion.

17. The method of claim 16, wherein the first portion and the second portion are removably attached to one another.

18. The method of claim 12, wherein securing the flexible jacket to the sensing member comprises securing a portion of the flexible jacket to a recessed portion of the sensing member.

19. An assembly including a temperature sensor, the assembly comprising:
a body including a channel having at least one bend, the channel ending at an edge;
a temperature probe comprising:
a plurality of fiber optic elements;
a sensing member having a first and a second end, the first end connected to distal portions of the plurality of fiber optic elements; and
a flexible jacket surrounding the plurality of fiber optic elements and engaged with the sensing member to prevent relative movement between the flexible jacket and the sensing member;
the temperature probe being at least within the channel and passing through the at least one bend to have the sensing member thermally communicate with the edge.

20. The assembly of claim 19, wherein the flexible jacket is a polytetrafluoroethylene jacket.

21. A flexible fiber optic temperature probe, the probe comprising:
a bundle of fiber optic elements;
a collar having an internal channel, the collar being secured to end portions of the bundle within the internal channel; and
a sensing member including a first part and a second part, the first part including:
a channel for receiving the collar, the first part being secured to the collar within the channel; and
a projection capable of being secured to adjacent walls; and
the second part including a sensing element.

22. The flexible fiber optic temperature probe of claim 21, wherein the first part and the second part are removably attached.

23. The flexible fiber optic temperature probe of claim 21, wherein the first part is adhesively fixed to the collar.

24. The flexible fiber optic temperature probe of claim 21, wherein the projection includes one or more surfaces for laser welding with the adjacent walls.

25. The flexible fiber optic temperature probe of claim 21, wherein at least part of the first part is insertable within a passage defined by the adjacent walls, and the projection prevents another part of the first part from being insertable within the passage.
